(19) United States
(12) Patent Application Publication
(10) Pub. No.: US 2014/0207536 A1
(43) Pub. Date: Jul. 24, 2014

(54) ELECTRONIC POLLING DEVICE

(71) Applicant: Everyone Counts, Inc., San Diego, CA (US)

(72) Inventors: Warren Scott, San Diego, CA (US); Roy Grossberg, San Diego, CA (US); Elan Kaplan, San Diego, CA (US); Craig Harold Reines, San Diego, CA (US); Jared O'Brien, San Diego, CA (US)

(73) Assignee: EVERYONE COUNTS, INC., San Diego, CA (US)

(21) Appl. No.: 14/163,771

(22) Filed: Jan. 24, 2014

Related U.S. Application Data
(60) Provisional application No. 61/756,395, filed on Jan. 24, 2013.

(51) Int. Cl. G07C 13/00

(52) U.S. Cl. CPC G07C 13/00
USPC 705/12

(57) ABSTRACT

The subject matter disclosed herein provides methods for authenticating a voter's identity using an electronic polling device. The method may search a plurality of voter profiles for a desired voter profile associated with a voter. The searching may be based on at least the voter's name or an associated voter ID. The method may display the desired voter profile which may include at least an image of the voter and an image of the voter's signature. The method may receive confirmation information from the voter. The method may compare the received confirmation information and a physical likeness of the voter with the desired voter profile to enable an authentication of the voter based on the comparing. The searching, displaying, receiving, comparing, and authenticating may be performed by at least one processor in an electronic polling device. Related apparatus, systems, techniques, and articles are also described.

### CROSS REFERENCE TO RELATED APPLICATION

This application claims the benefit of priority under 35 U.S.C. §119(e) of U.S. provisional patent application No. 61/756,395, entitled “Electronic Polling Device,” filed on Jan. 24, 2013. The contents of the above-identified application are incorporated herein by reference in their entirety.

### TECHNICAL FIELD

This disclosure relates generally to an electronic voting system and, more particularly, to the authentication of a voter's identity using an electronic polling device having access to stored voter profiles.

### BACKGROUND

Authentication of a voter's identity is required before a voter is allowed to cast a vote. In most jurisdictions, a voter is assigned to a poll station based on the voter's precinct. At the poll station, the voter may present an identification card to a poll monitor. A poll monitor may compare the information in the voter's identification card against the poll station's written records. Based on this comparison, a poll monitor may allow or prevent a voter from voting.

There are drawbacks associated with this process. The written records at a poll station are generally limited to a list of names and addresses. Given the meager information in these records, an impostor can easily defraud the authentication process by presenting a counterfeit identification card with a matching name and address.

### SUMMARY

In some implementations, methods and apparatus, including computer program products, are provided for authenticating a voter's identity using an electronic polling device.

In one aspect, a plurality of voter profiles is searched for a desired voter profile associated with a voter. The desired voter profile is displayed. The searching is based on at least a name or a voter ID associated with the voter. The desired voter profile includes at least an image of the voter and an image of a signature associated with the voter. Confirmation information is received from the voter. The received confirmation information and a physical likeness of the voter are compared with the desired voter profile to enable an authentication of the voter based on the comparing. The searching, displaying, receiving, comparing, and authenticating are performed by at least one processor in an electronic polling device.

The above methods, apparatus, and computer program products may, in some implementations, further include one or more of the following features.

The receiving of the confirmation information may include prompting the voter for a handwritten signature and capturing the handwritten signature.

The voter may be assigned to a voting station after the voter is authenticated. A ballot style may be assigned to the voter based on the voter profile. The assigned ballot style may be transmitted to the assigned voting station.

The name or the voter ID may be obtained by scanning a barcode on an identification card belonging to the voter or on ballot materials belonging to the voter.

The captured handwritten signature, the image of the signature in the desired voter profile, and an image of the voter in the desired voter profile may be displayed during the comparing. The voter may be prompted for a second handwritten signature based on the comparing of the handwritten signature with the image of the signature in the desired voter profile.

The electronic polling device may possess a geopositioning functionality comprising GPS functionality. The searching may be limited to a subset of the plurality of voter profiles that are associated with a geographic region of the electronic polling device. The geographic region may be determined using the GPS functionality. The geographic region may be a precinct, a county, or a state.

It may be determined whether the voter is assigned to a poll station associated with the electronic polling device by comparing, using the GPS functionality, an assigned poll station in the voter profile with an address of the electronic polling device. The voter may be redirected to the assigned poll station if the assigned poll station is not the same as the address of the electronic polling device. The redirecting may include displaying a location of the assigned poll station on a map, and displaying driving directions to the assigned poll station.

In some example embodiments, one of more variations may be made as well as described in the detailed description below and/or as described in the following features.

It is to be understood that both the foregoing general description and the following detailed description are exemplary and explanatory only and are not restrictive. Further features and/or variations may be provided in addition to those set forth herein. For example, the implementations described herein may be directed to various combinations and subcombinations of the disclosed features and/or combinations and subcombinations of several further features disclosed below in the detailed description.

### DESCRIPTION OF DRAWINGS

The accompanying drawings, which are incorporated herein and constitute a part of this specification, show certain aspects of the subject matter disclosed herein and, together with the description, help explain some of the principles associated with the subject matter disclosed herein. In the drawings,

FIG. 1 illustrates a poll station, in accordance with some example implementations;

FIG. 2 illustrates a voter search interface, in accordance with some example implementations;

FIG. 3 illustrates a voter profile, in accordance with some example implementations;

FIG. 4 illustrates a poll station locator, in accordance with some example implementations;

FIG. 5 illustrates a signature window, in accordance with some example implementations;

FIG. 6 illustrates a voter profile and a captured signature, in accordance with some example implementations;

FIG. 7 illustrates a poll station status window, in accordance with some example implementations; and

FIG. 8 illustrates a method for authenticating a voter using an electronic polling device, in accordance with some example implementations.

Like reference symbols in the various drawings indicate like elements.

### DETAILED DESCRIPTION

Implementations of the subject matter disclosed herein are directed to the authentication of a voter's identity using an electronic polling device. In some implementations, this authentication process may include searching a voter database for a desired voter profile. The desired voter profile may include an image of the voter's signature. Using the electronic polling device, a poll monitor may capture the voter's handwritten signature and authenticate the voter's identity by comparing the captured signature with the signature stored in the database.

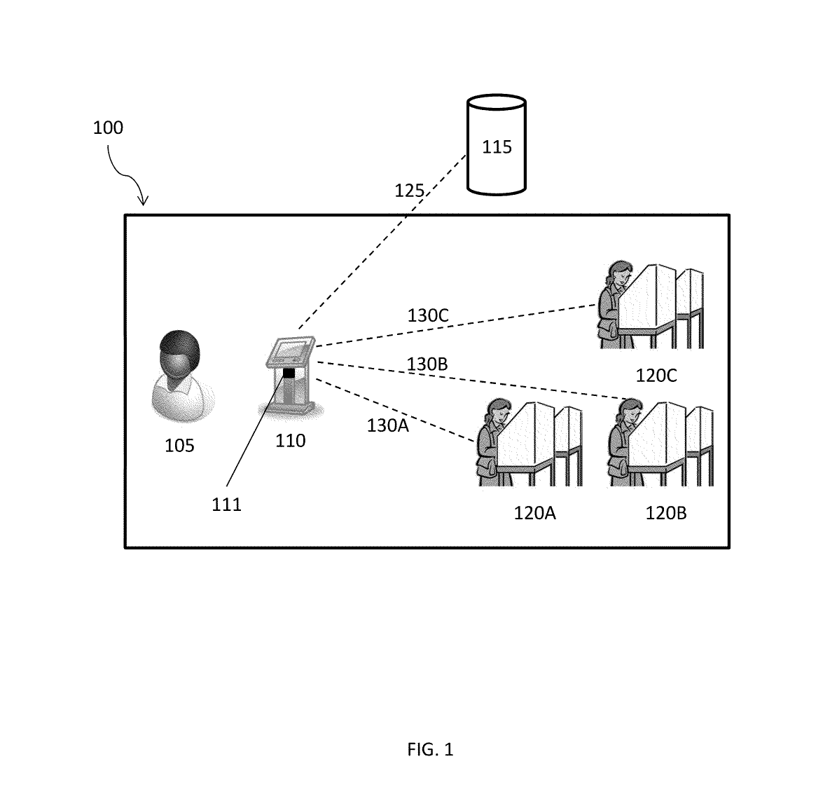

FIG. 1 illustrates a poll station 100 at which a voter 105 may cast a vote in a public election or private contest. When voter 105 arrives at poll station 100, he/she may check in with the poll monitor. The poll monitor may authenticate the identity of voter 105 using electronic polling device 110 before allowing the voter to cast a vote. Electronic polling device 110 may be implemented as a tablet computer, an electronic reader, a laptop, a desktop computer, a smartphone, and the like.

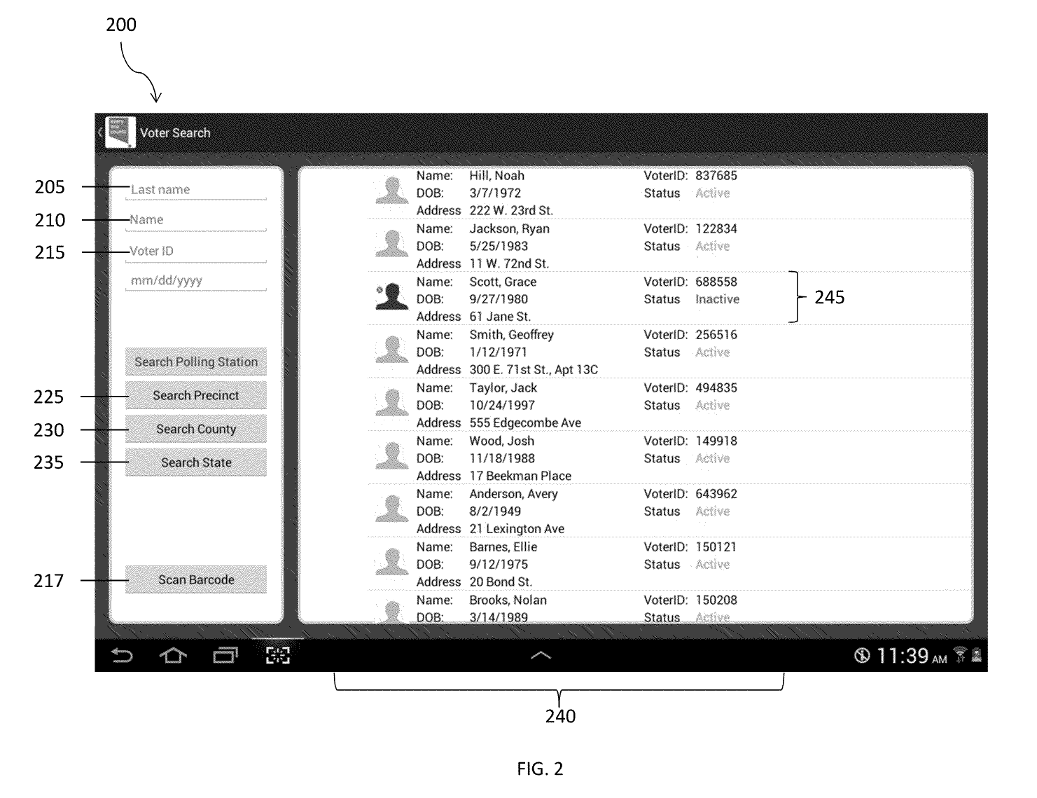

Electronic polling device 110 may be loaded with a voter authentication program that displays voter search interface 200 displayed in FIG. 2. Voter search interface 200 may be used to search for a voter profile associated with voter 105. In order to search for this voter profile, the poll monitor may ask voter 105 for his/her last name, first name, and/or voter ID and enter this information into fields 205, 210, and/or 215, respectively. In some implementations, the poll monitor or the voter may type this information directly into electronic polling device 110 using an attached keyboard. Alternatively, this information may be entered into electronic polling device 110 by scanning this information in from a barcode. This barcode may be printed on an identification card belonging to voter 105 or on ballot materials sent to the voter in advance of the election. This option may be selected by pressing button 217. In some implementations, this information may be transferred to electronic polling device 110 via a token, USB flash drive, and the like.

Upon receiving the information in fields 205, 210, and/or 215, electronic polling device 110 may search internal memory 111 on the electronic polling device for the desired profile. Although the following paragraphs are directed to the searching of voter profiles that are locally stored at electronic polling device 110, in some implementations these profiles may be remotely stored at server 115. In these implementations, electronic polling device 110 may transmit the information in fields 205, 210, and 215 to server 115 using communication link 125 to search for the desired voter profile. In some implementations, communication link 125 may be a wired or wireless connection.

Memory 111 may store voter profiles for voters that reside in different states, counties, and precincts. In order to hasten the search for the profile of voter 105, electronic polling device 110 may be configured to filter the voter profiles stored in memory 111 to display only those voters belonging to the same precinct as the precinct in which the electronic polling device is being used. The poll monitor may activate this precinct filter by selecting button 225. Similarly, the poll monitor may activate a county or state filter by selecting buttons 230 or 235, respectively.

In some implementations, electronic polling device 110 may be enabled with geopositioning functionality such as a global positioning system (GPS). This functionality may be utilized when the geographical filters described above are activated. For example, if the poll monitor activates the precinct filter, electronic polling device 110 may determine its current address using its GPS functionality and map this location to a specific precinct. Similarly, electronic polling device 110 may utilize its GPS functionality to determine the state or county in which it resides to apply filters 230 and 235, respectively.

If voter profiles are stored remotely at server 115 instead of memory 111, electronic poll station 110 may transmit its precinct, county, and/or state information to server 115 to decrease the number of voter profiles that must be searched at the server. Electronic polling device 110 may transmit these geographical indications to server 115 when it transmits the information in fields 205, 210, and 215. In some implementations, electronic polling device 110 may transmit these geographical indications when the electronic polling device is first powered on or when it resumes operation from an idle state.

Using the information in fields 205, 210, and 215 and the geographical filters described above (if any are selected), electronic polling device 110 may search memory 111 for the desired profile and display a list of voters 240 that match one or more of these criteria. The poll monitor may select the desired voter from list 240. In the example of FIG. 2, voter 245 may be selected as indicated by the darkened icon next to the voter's name.

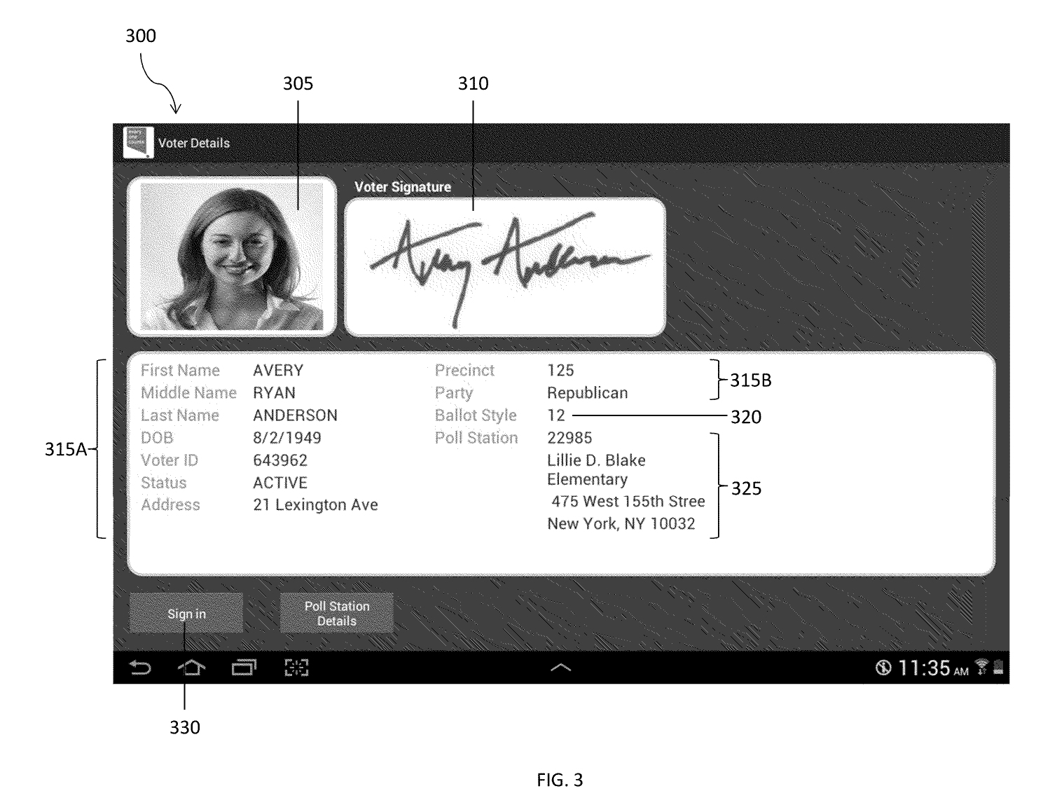

Once a voter is selected from list 240, electronic polling device 110 may display the associated voter profile 300 as shown in FIG. 3. The information included in voter profile 300 may vary depending on the voting laws of the jurisdiction in which electronic polling device 110 is used. In the example of FIG. 3, voter profile 300 may include an image 305 of voter 105, an image 310 of the voter's signature, personal information 315A and 315B relating to the voter, and ballot style 320. Ballot style 320 may identify the various contests that voter 105 is eligible to vote in and the choices available in each contest. Personal information 315A may include, for example, the first, middle, and last names of voter 105, the voter's date of birth, voter identification number, voter registration status, and address. Personal information 315B may include, for example, the voter's precinct and political party affiliation. If, for example, electronic polling device 110 is used in a jurisdiction that does not require photo identification to authenticate a voter, image 305 of voter 105 may be removed from voter profile 300.

Profile 300 may also indicate the poll station 325 that voter 105 is assigned to. Using its GPS functionality, electronic polling device 110 may determine if voter 105 is at the correct (i.e., the voter's assigned) poll station by comparing the address of poll station 325 with the current address of the electronic polling device. If the address of poll station 325 matches the current address of electronic polling device 110, then voter 105 may be at the correct poll station. If, however, these values do not match, then voter 105 may be at an incorrect poll station.

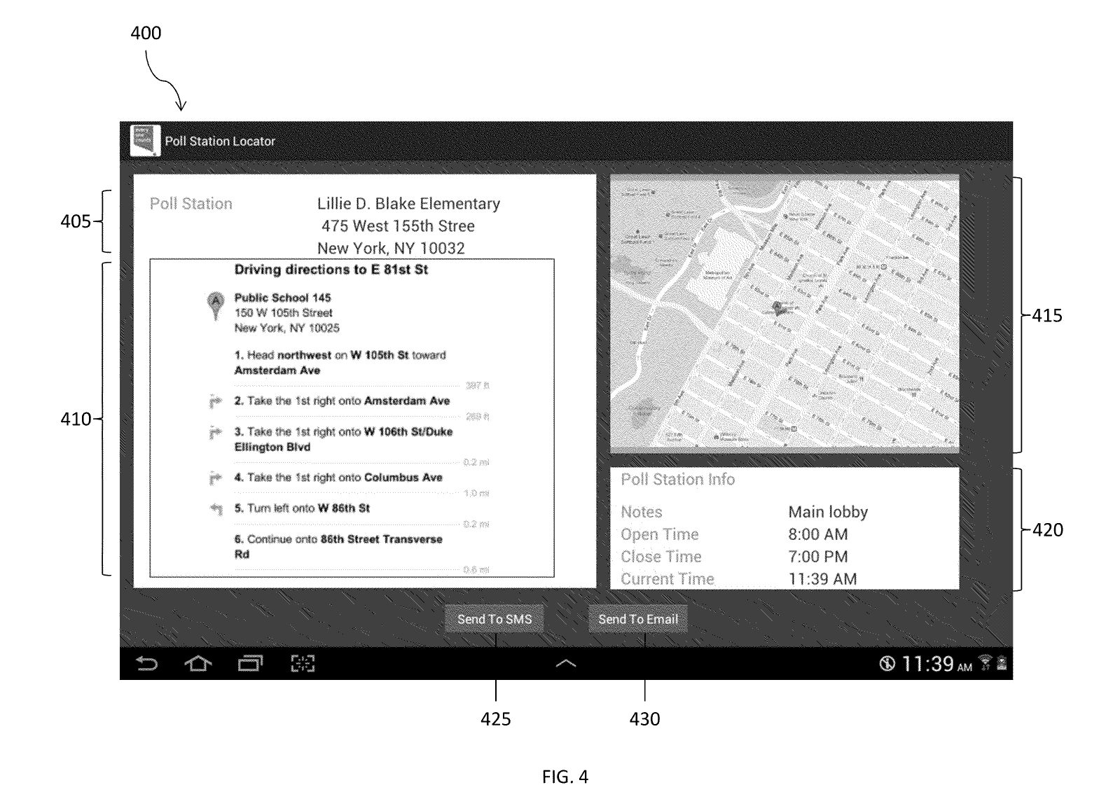

In this latter scenario, electronic poll device 100 may redirect voter 105 to his/her assigned poll station by displaying poll station locator 400 in FIG. 4. Poll station locator 400 may display the address 405 of the poll station, driving directions 410 to the poll station, the location of the poll station on map 415, and information 420 regarding the poll station. The information 420 displayed in poll station locator 400 may include, for example, the operating hours of the poll station and any relevant notes. Electronic polling device 110 may send the information displayed in poll station locator 400 to the voter either by text message to a mobile telephone number or by e-mail when buttons 425 or 430, respectively, are selected.

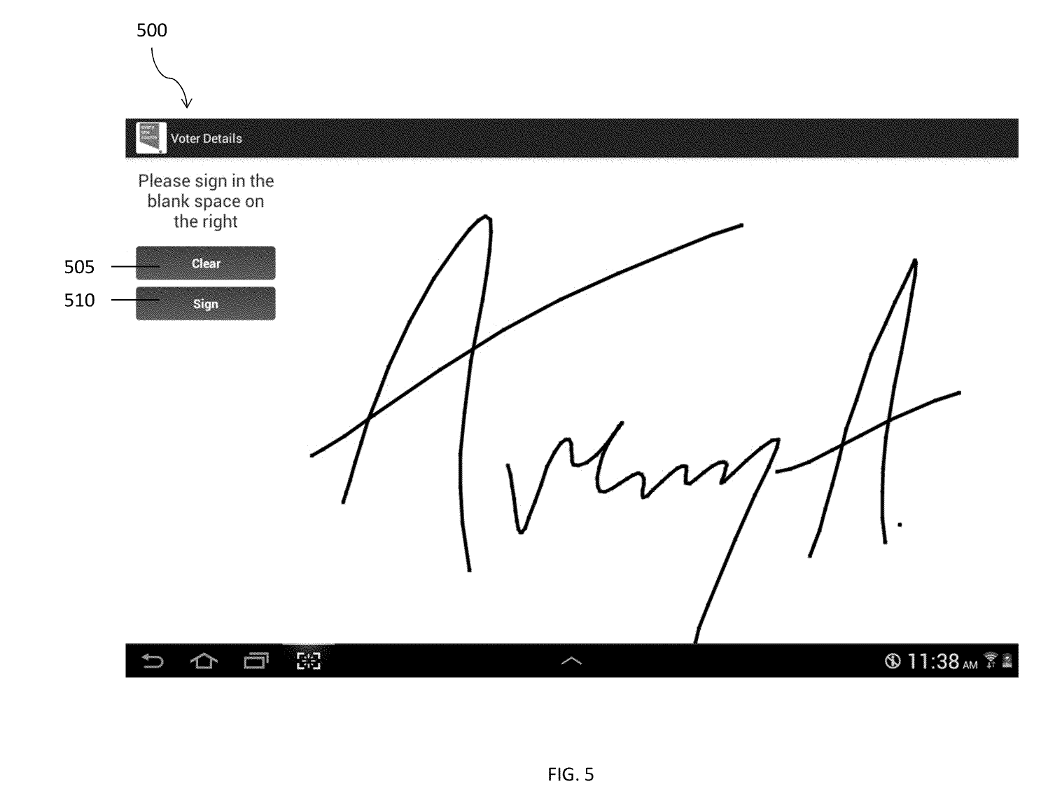

Referring again to FIG. 3, if voter 105 is at the correct poll station, then the voter may sign in by selecting button 330. Upon doing so, electronic polling device 110 may prompt voter 105 to provide a handwritten signature in signature window 500 of FIG. 5. Voter 105 may use his/her finger, stylus, or other writing implement to provide a handwritten signature directly on electronic polling device 110. If voter 105 is not satisfied with the signature, he/she may clear the screen by selecting button 505 to start over again. To accept the signature, voter 105 may select button 510.

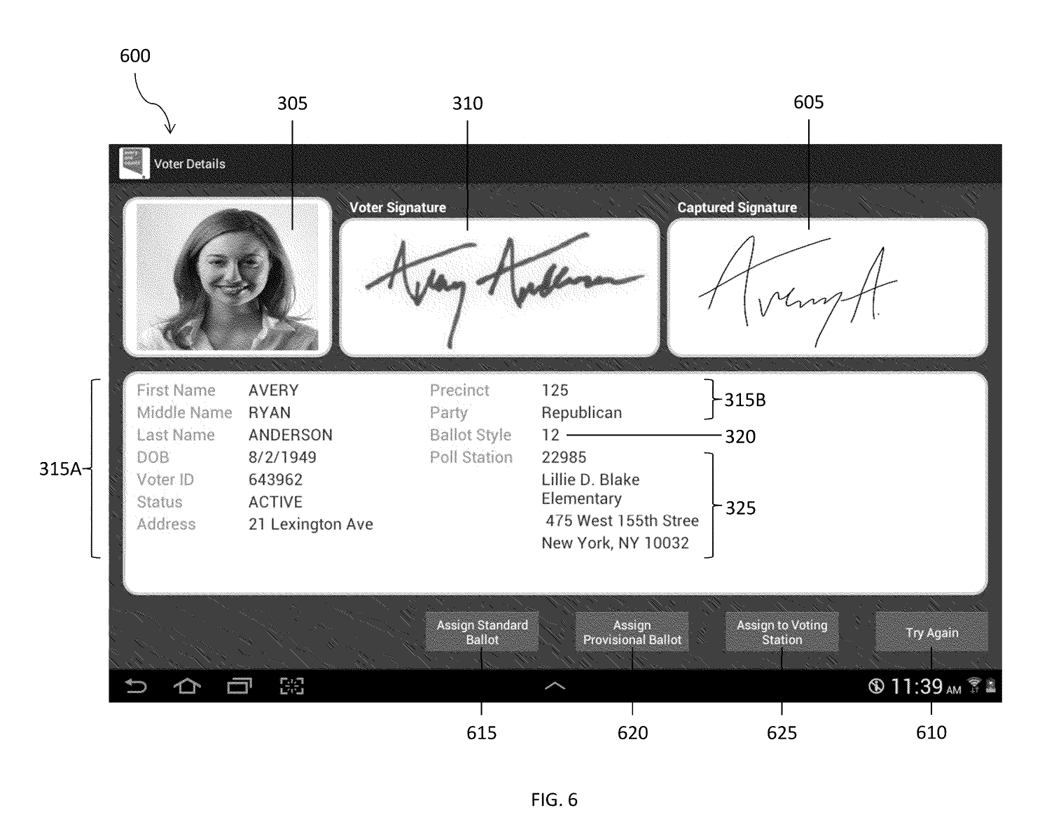

Once the signature has been accepted, electronic polling device 110 may display voter profile 600 as illustrated in FIG. 6. Similar to voter profile 300, the information included in voter profile 600 may vary depending on the voting laws of the jurisdiction in which electronic polling device 110 is used. In the example of FIG. 6, voter profile 600 may include an image 305 of voter 105, an image 310 of the voter's signature, personal information 315A and 315B relating to the voter, and ballot style 320. Voter profile 600 may also display a captured signature 605. Captured signature 605 may correspond to the accepted handwritten signature provided in signature window 500.

The poll monitor may compare captured signature 605 with image 310 of the voter's signature to confirm the identity of voter 105. If the signatures are substantially identical to each other, then the poll monitor may conclude that voter 105 is who he/she claims to be. If, however, the signatures are not substantially identical to each other, then the poll monitor may prompt the voter to provide a second handwritten signature by selecting button 610 which, in turn, brings electronic polling device 110 back to signature window 500. In some implementations, electronic polling device 110 may be able to perform this comparison using handwriting recognition software loaded onto the device and display a message to indicate whether the signatures are substantially identical to each other. As an added level of security, the poll monitor may also use image 305 of the voter to verify the voter's physical likeness. In jurisdictions where photo identification is not required to authenticate a voter, voter profile 600 may not include image 305 of the voter, and this latter comparison may not be performed.

If the poll monitor is satisfied with the comparison of the voter's signatures and/or physical likeness, the poll monitor may assign a ballot to voter 105 using electronic polling device 110. As illustrated in FIG. 6, the poll monitor may assign either a standard ballot (by selecting button 615) or a provisional ballot (by selecting button 620) to voter 105. The poll monitor may also assign voter 105 to a voting station by selecting button 625.

Upon selection of button 625, electronic polling device 110 may determine if there are any vacant voting stations among stations 120A, 120B, and 120C. If a vacant voting station is found, electronic polling device 110 may display a message that identifies the vacant station and prompts voter 105 to proceed to the station. If either button 615 or 620 is also selected, electronic polling device 110 may electronically transmit the appropriate ballots for voter 105 to the designated voting station using one of communication links 130A, 130B, and 130C. When a standard ballot is selected (i.e., button 615), electronic polling device 110 may select the correct ballot for voter 105 by referring to the designated ballot style 320 in voter profile 600. Communication links 130A, 130B, and 130C may be implemented as wired or wireless connections.

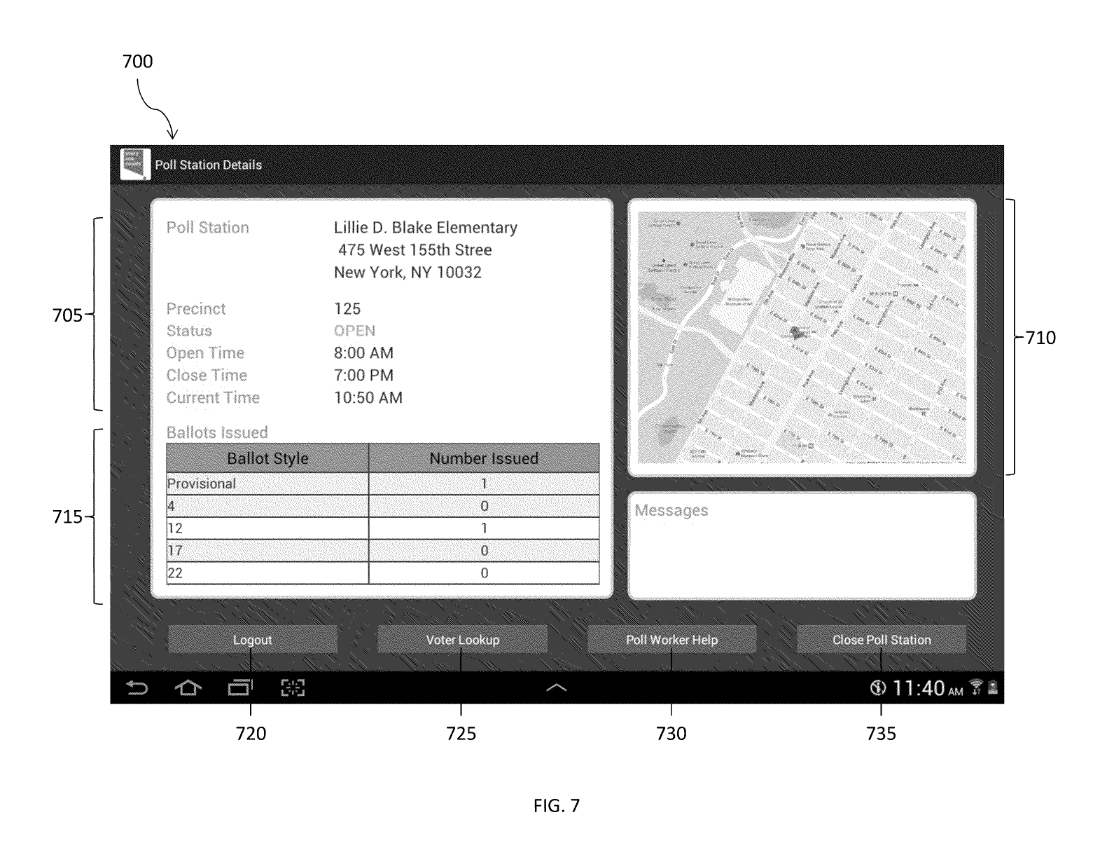

FIG. 7 illustrates a poll station status window 700 that displays general information 705 regarding the poll station, the location of the poll station on map 710, and the number of ballots that have been issued 715. The information in 715 may provide details regarding the number of ballot styles that are available at the poll station and the number of ballots for each ballot style that has been issued. Electronic polling device 110 may automatically update the information in 715 throughout the course of voting as ballots are assigned using buttons 615 and 620 as described above.

Poll station status window 700 may also include several action buttons. Pressing button 720 may log the user out of electronic polling device 110. Pressing button 725 may allow a poll monitor to search for a voter. In some implementations, pressing button 725 may bring up voter search interface 200. Pressing button 730 may alert poll workers that help is needed. Pressing button 735 may close the poll station. A poll monitor may press button 735 when the poll station closes.

In addition to authenticating a voter as described above, electronic polling device 110 may also be used to verify that the poll monitor operating the electronic polling device is authorized to do so. When electronic polling device 110 is powered on or resumes activity from an idle state, the device may prompt the poll monitor to enter a username and password combination. In some implementations, this combination may alternatively or optionally include a MAC address or IP address of electronic polling device 110. If electronic polling device 110 is unable to verify this combination, then the device will not activate. If, however, this combination is verified, electronic polling device 110 may additionally determine whether it is being used at a designated poll station. This additional step may provide an added layer of protection that may prevent, for example, a genuine poll monitor from operating a rogue poll station from an unauthorized location. Electronic polling device 110 may utilize its GPS functionality to make this determination by identifying its current location and determining whether this location is within a designated radius of the poll station. If the electronic polling device is within the designated radius of the poll station, then electronic polling device may be used. Otherwise, the electronic polling device may render itself inoperable.

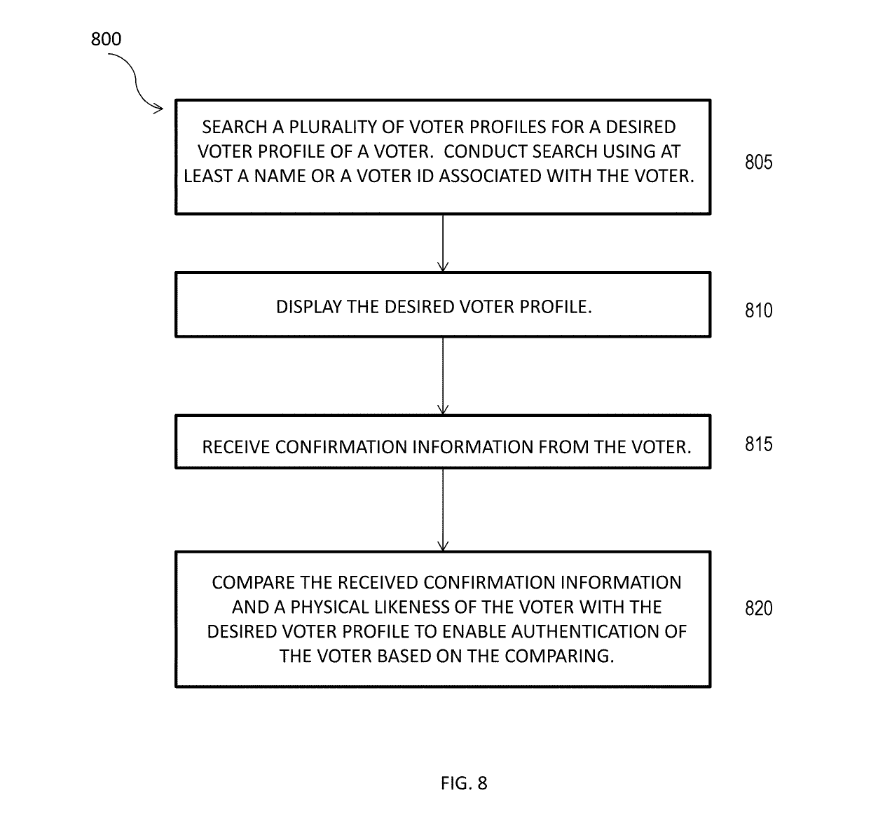

FIG. 8 illustrates a method 800 for operating electronic polling device 110. At 805, electronic polling device 110 may search a plurality of voter profiles for a desired voter profile of a particular voter. Electronic polling device 110 may conduct this search using the voter's first and last name, last name, and/or voter ID. The voter or poll monitor may, for example, type this information directly into electronic polling device 110. In some implementations, electronic polling device 110 may receive this information by scanning a barcode on an identification card or ballot materials belonging to the voter. In implementations where voter profiles are stored at a remote server 115, electronic polling device 110 may transmit this identifying information to the server, and the server may perform the searching. In some implementations, the processing at 805 may proceed after verifying that the poll monitor operating the electronic polling device is authorized to do so.

At 810, the electronic polling device may display the voter profile belonging to the voter. In some implementations, the displayed voter profile may include an image 305 of the voter and an image 310 of a signature associated with the voter. In jurisdictions where photo identification is not required to authenticate a voter, image 305 of the voter may be removed from the voter profile. The displayed voter profile may also include the first, middle, and last names of the voter as well as the voter's date of birth, identification number, voter registration status, address, precinct and political party affiliation. In some implementations, the displayed voter profile may also indicate the ballot style that should be assigned to the voter and the poll station that the voter is assigned to.

At 815, electronic polling device 110 may receive confirmation information from the voter. In some implementations, the confirmation information may be received by prompting the voter for a handwritten signature and capturing the handwritten signature. This may be done, for example, using signature window 500. The voter may provide a handwritten signature by writing directly on electronic polling device 110 using, for example, his/her finger, a stylus, and the like.

At 820, the received confirmation information and a physical likeness of the voter may be compared with information in the voter profile. During the comparing, electronic polling device 110 may display, for example, the captured handwritten signature 605 alongside the image 310 of the voter's signature in the voter profile. If these two signatures are not substantially identical with each other, the electronic polling device may prompt the voter to provide a second handwritten signature using signature window 500. In some implementations, a poll monitor may additionally use the image 305 of the voter in the voter profile to verify the physical likeness of the voter. This latter verification, however, may be unnecessary in jurisdictions that do not require photo identification to authenticate a voter. As previously explained, image 305 may be absent from the voter profile in these jurisdictions. Based on the comparing done at 820, the electronic polling device may authenticate the voter.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results.

What is claimed is:

1. A method comprising:
searching a plurality of voter profiles for a desired voter profile associated with a voter, the searching based on at least a name or a voter ID associated with the voter;
displaying the desired voter profile, the desired voter profile including at least an image of the voter and an image of a signature associated with the voter;
receiving confirmation information from the voter; and
comparing the received confirmation information and a physical likeness of the voter with the desired voter profile to enable an authentication of the voter based on the comparing,
wherein the searching, displaying, receiving, comparing, and authenticating are performed by at least one processor in an electronic polling device.

2. The method of claim 1, wherein the receiving the confirmation information comprises:
prompting the voter for a handwritten signature; and
capturing the handwritten signature.

3. The method of claim 1 further comprising:
assigning the voter to a voting station after authenticating the voter;
assigning a ballot style to the voter based on the voter profile; and
transmitting the assigned ballot style to the assigned voting station.

4. The method of claim 1, wherein the name or the voter ID is obtained by scanning a barcode on an identification card belonging to the voter or on ballot materials belonging to the voter.

5. The method of claim 2, further comprising:
displaying the captured handwritten signature, the image of the signature in the desired voter profile, and an image of the voter in the desired voter profile during the comparing.

6. The method of claim 5, further comprising:
prompting the voter for a second handwritten signature based on the comparing of the handwritten signature with the image of the signature in the desired voter profile.

7. The method of claim 1, wherein the electronic polling device possesses a geopositioning functionality comprising GPS functionality, and
wherein the searching is limited to a subset of the plurality of voter profiles that are associated with a geographic region of the electronic polling device, the geographic region determined using the GPS functionality.

8. The method of claim 7, wherein the geographic region is a precinct, a county, or a state.

9. The method of claim 7, further comprising:
determining whether the voter is assigned to a poll station associated with the electronic polling device by comparing, using the GPS functionality, an assigned poll station in the voter profile with an address of the electronic polling device; and
redirecting the voter to the assigned poll station if the assigned poll station is not the same as the address of the electronic polling device.

10. The method of claim 9, wherein the redirecting comprises:
displaying a location of the assigned poll station on a map; and
displaying driving directions to the assigned poll station.

11. A non-transitory computer-readable medium containing instructions to configure a processor to perform operations comprising:
searching a plurality of voter profiles for a desired voter profile associated with a voter, the searching based on at least a name or a voter ID associated with the voter;
displaying the desired voter profile, the desired voter profile including at least an image of the voter and an image of a signature associated with the voter;
receiving confirmation information from the voter; and
comparing the received confirmation information and a physical likeness of the voter with the desired voter profile to enable an authentication of the voter based on the comparing.

12. The non-transitory computer-readable medium of claim 11, wherein the receiving the confirmation information comprises:
prompting the voter for a handwritten signature; and
capturing the handwritten signature.

13. The non-transitory computer-readable medium of claim 11 further comprising:
assigning the voter to a voting station after authenticating the voter;
assigning a ballot style to the voter based on the voter profile; and
transmitting the assigned ballot style to the assigned voting station.

14. The non-transitory computer-readable medium of claim 11, wherein the name or the voter ID is obtained by scanning a barcode on an identification card belonging to the voter or on ballot materials belonging to the voter.

15. The non-transitory computer-readable medium of claim 11, wherein the electronic polling device possesses a geopositioning functionality comprising GPS functionality, and
wherein the searching is limited to a subset of the plurality of voter profiles that are associated with a geographic region of the electronic polling device, the geographic region determined using the GPS functionality.

16. A system comprising:
a processor; and
a memory, wherein the process and the memory are configured to perform operations comprising:
searching a plurality of voter profiles for a desired voter profile associated with a voter, the searching based on at least a name or a voter ID associated with the voter;
displaying the desired voter profile, the desired voter profile including at least an image of the voter and an image of a signature associated with the voter;
receiving confirmation information from the voter; and
comparing the received confirmation information and a physical likeness of the voter with the desired voter profile to enable an authentication of the voter based on the comparing.

17. The system of claim 16, wherein the receiving the confirmation information comprises:
prompting the voter for a handwritten signature; and
capturing the handwritten signature.

18. The system of claim 16 further comprising:
assigning the voter to a voting station after authenticating the voter;
assigning a ballot style to the voter based on the voter profile; and
transmitting the assigned ballot style to the assigned voting station.

19. The system of claim 16, wherein the name or the voter ID is obtained by scanning a barcode on an identification card belonging to the voter or on ballot materials belonging to the voter.

20. The system of claim 16, wherein the electronic polling device possesses a geopositioning functionality comprising GPS functionality, and
wherein the searching is limited to a subset of the plurality of voter profiles that are associated with a geographic region of the electronic polling device, the geographic region determined using the GPS functionality.
